(19) United States
(12) Patent Application Publication
(10) Pub. No.: US 2004/0135337 A1
(43) Pub. Date: Jul. 15, 2004

(54) Structural member for a suspension of a motor vehicle and method for its production

(76) Inventors: Guido Sebastiano Alesso, Savigliano (IT); Michele Spina, Torino (IT)

Correspondence Address: SUGHRUE MION, PLLC, 2100 PENNSYLVANIA AVENUE, N.W., SUITE 800, WASHINGTON, DC, 20037, US

(21) Appl. No.: 10/471,770

(22) PCT Filed: Mar. 12, 2002
(86) PCT No.: PCT/IB02/00756

(30) Foreign Application Priority Data
Mar. 16, 2001 (IT) TO2001A000253

(51) Int. Cl. B60G 3/04

(52) U.S. Cl. 280/124.134

(57) ABSTRACT

The member (2), particularly adapted for an arm (1) of which a motor vehicle suspension, has a box-like structure which comprises a pair of shaped portions (3, 4) disposed facing each other. Said portions are obtained from a pair of integral plate portions (3′, 4′) of a semi-finished product (2′) in the form of a shaped, essentially flat element, produced starting from a plastically deformable material in sheet form, by folding over the shaped element (2′) along at least one predetermined line (16, 17), so as to dispose the plate portions (3′, 4′) facing each other.

The present invention relates to a structural member for a suspension of a motor vehicle, in particular a suspension arm, having a box-like structure, as specified in the preamble of claim 1, and further to a method for the production of such a member, as specified in the preamble of claim 15.

Members having a box-like structure, used in suspension arms for motor vehicles, are currently produced by arranging facing each other two separate portions, or half-shells, obtained in a conventional manner by means of pressing operations, and then proceeding with the fixing of such portions, for example by means of welding along at least a part of their perimeter.

It is an aim of the present invention to provide a structural member having a box-like structure, in particular an arm for a motor vehicle suspension, and a method for its production, which make it possible to remedy the typical drawbacks of the members with box-like structure currently produced and of the methods for their production, making available embodiments thereof which are structurally stronger and adapted to be produced less expensively and with a smaller amount of scrap.

These and other aims and advantages, which will become clearer from the following description, are achieved through the structural member with box-like structure and the method for its production according to the present invention. Said structural member and the production method thereof are characterised as defined in the appended claims, and in particular in that the member consists of a first and a second arm portion which are shaped as half-shells and obtained from two integral plate portions of a single shaped essentially flat element produced by blanking from a substantially rigid and plastically deformable material in sheet form, by folding over said shaped element along at least one predetermined line, so as to dispose the aforesaid plate portions thereof substantially facing each other.

The invention will be described in more detail hereinafter, purely by way of non-limiting example, with reference to the appended drawings, in which:

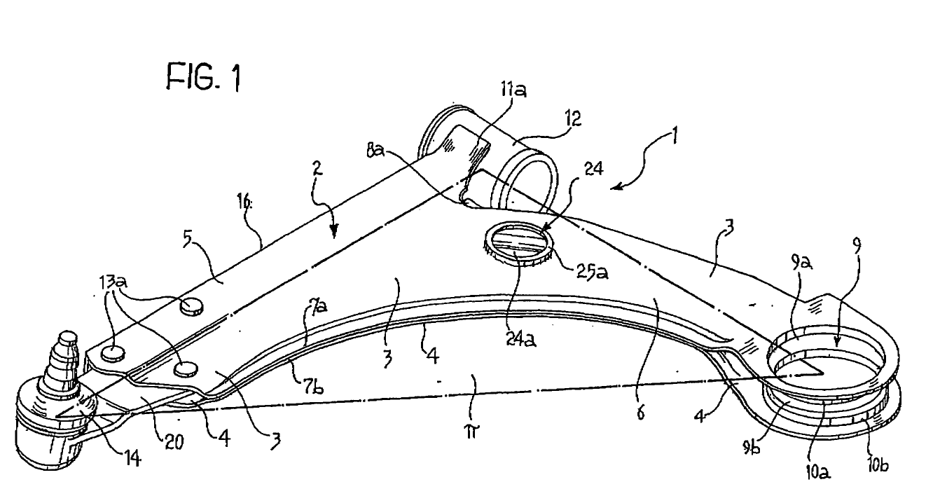

FIG. 1 is a perspective view of a structural member with box-like structure, according to a first preferred embodiment of the invention, used as an arm of a suspension for a motor vehicle;

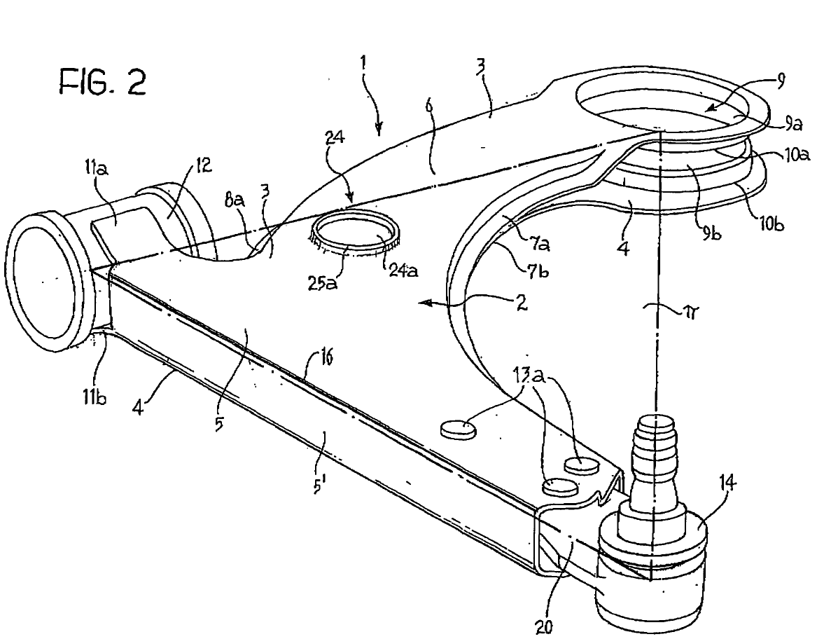

FIG. 2 is a second perspective view of the structural member of FIG. 1;

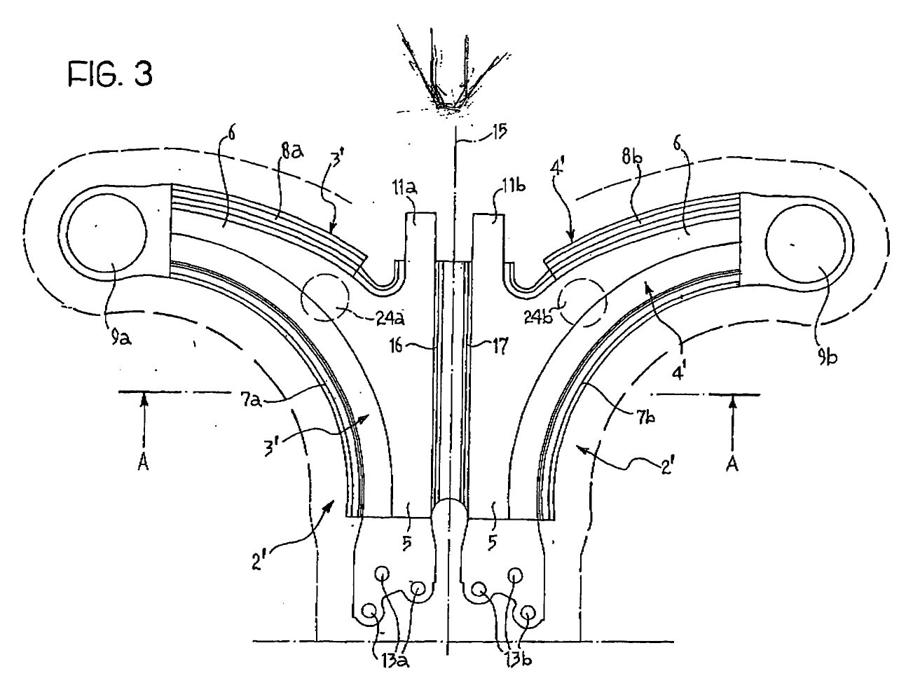

FIG. 3 shows the profile in plan view of the starting semi-finished product from which the structural member of FIGS. 1 and 2 is obtained;

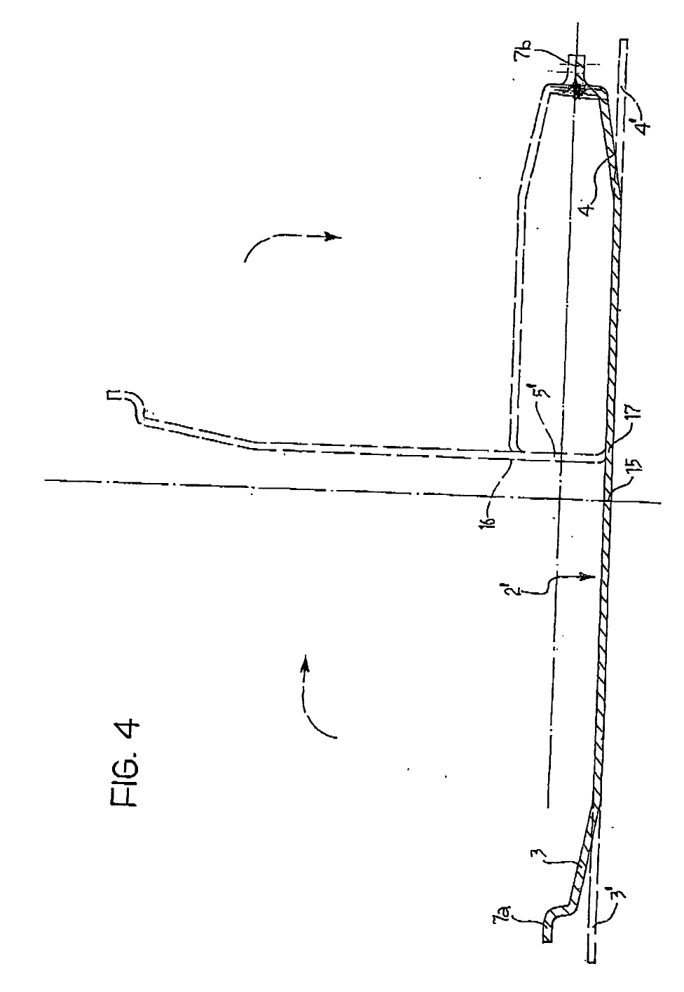

FIG. 4 shows a front view of the semi-finished product of FIG. 3, in section along a plane A-A, in which are indicated by means of dashed lines the successive folding stages necessary for the production according to the invention of the structural member of FIGS. 1 and 2,

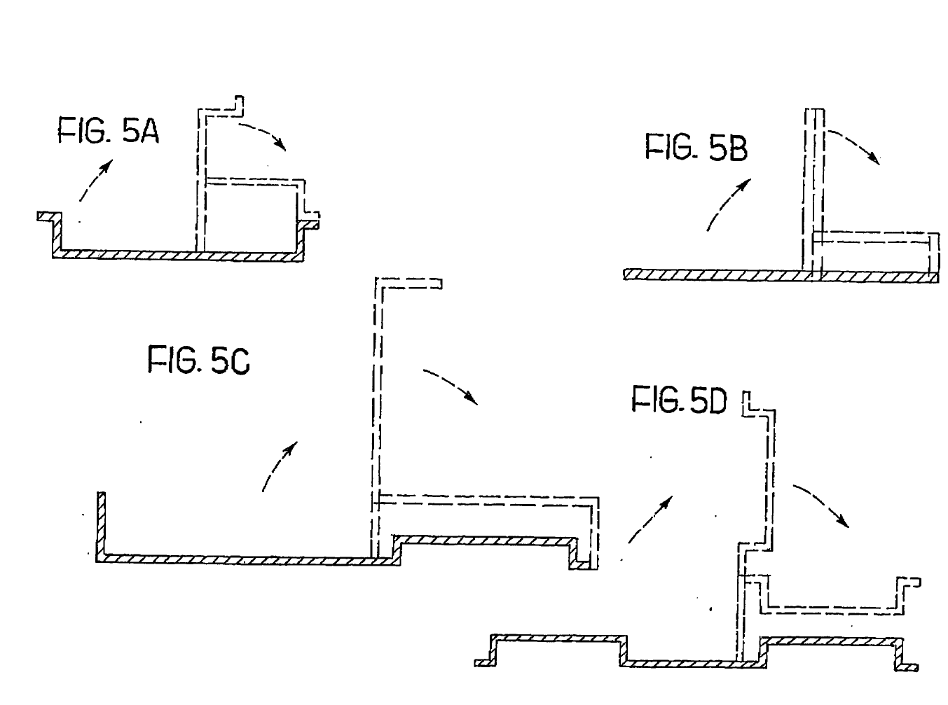

FIGS. 5A to 5D give some examples of combinations of the forms of the two portions constituting a structural member according to the invention;

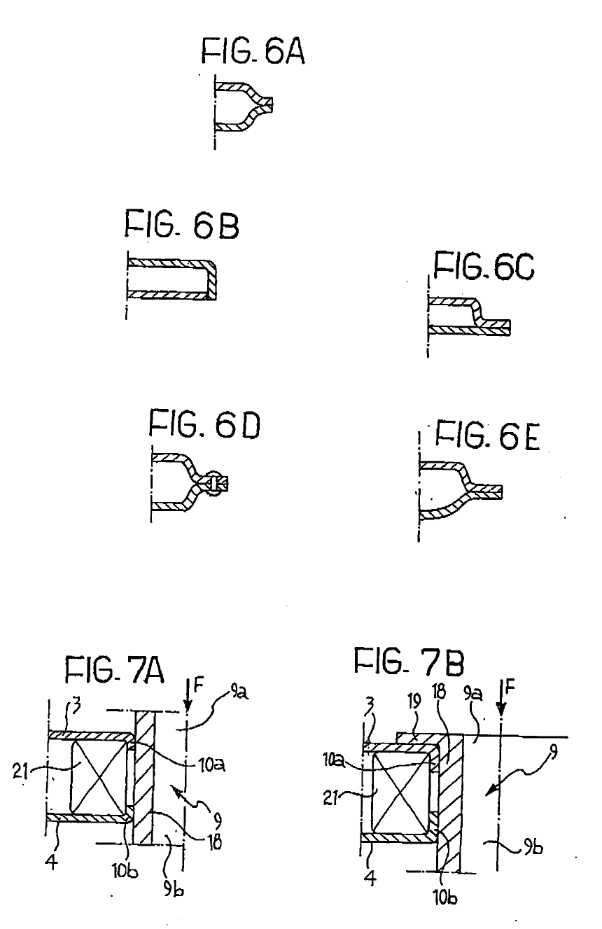

FIGS. 6A to 6F illustrate various possible types of embodiment of the joining edges of the two portions of a structural member according to the invention;

FIGS. 7A and 7B show two examples of the mounting of an intermediate connection device, in particular of a bush with vertical axis, between the two portions of a structural member according to the invention;

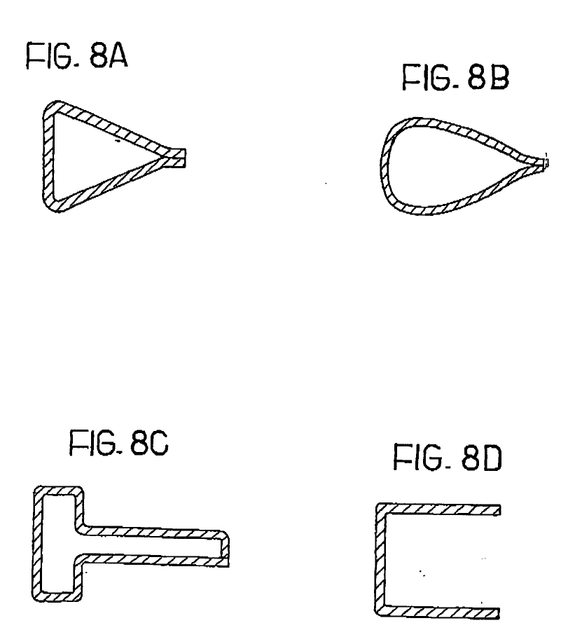

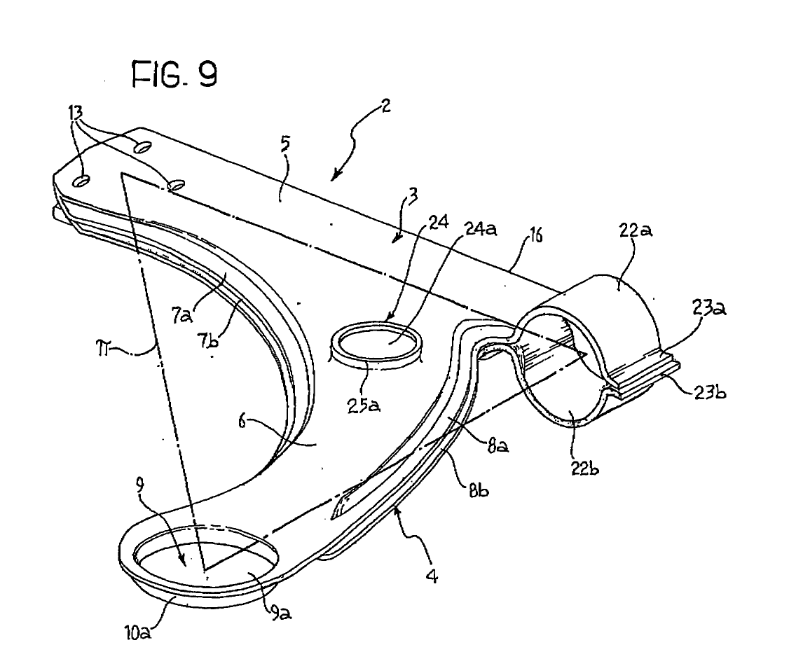

FIGS. 8A to 8D illustrate some examples of shapes which the cross-section of a structural member according to the invention can assume;

FIG. 9 is a perspective view of a further preferred embodiment of a structural member with box-like structure according to the invention;

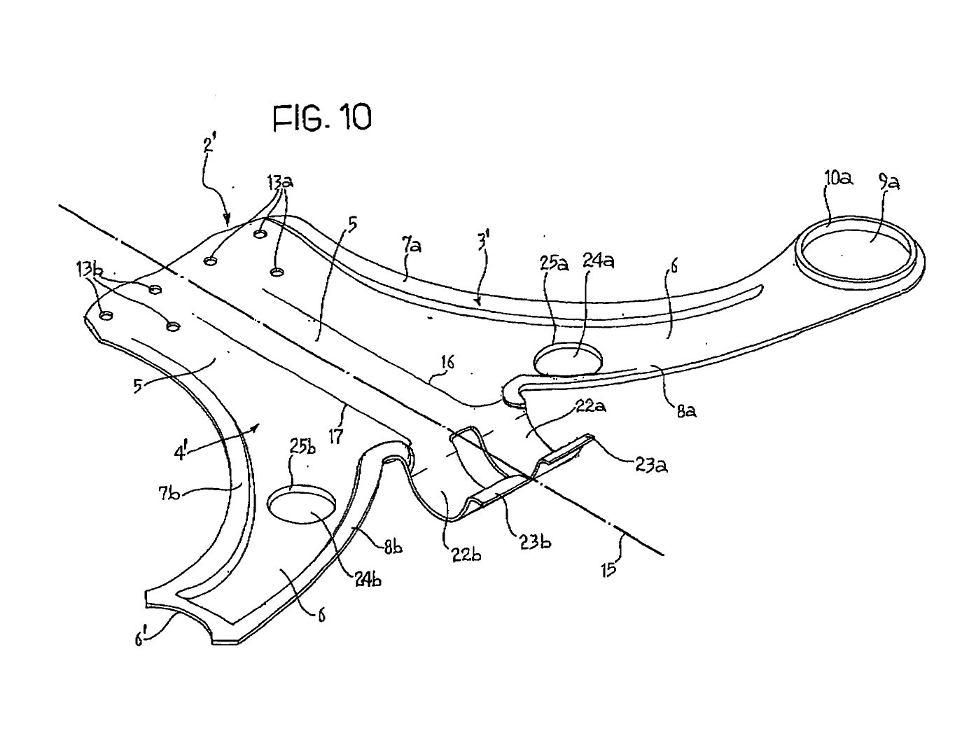

FIG. 10 is a perspective view of a semi-finished product from which the structural member of FIG. 9 is obtained by successive folding operations;

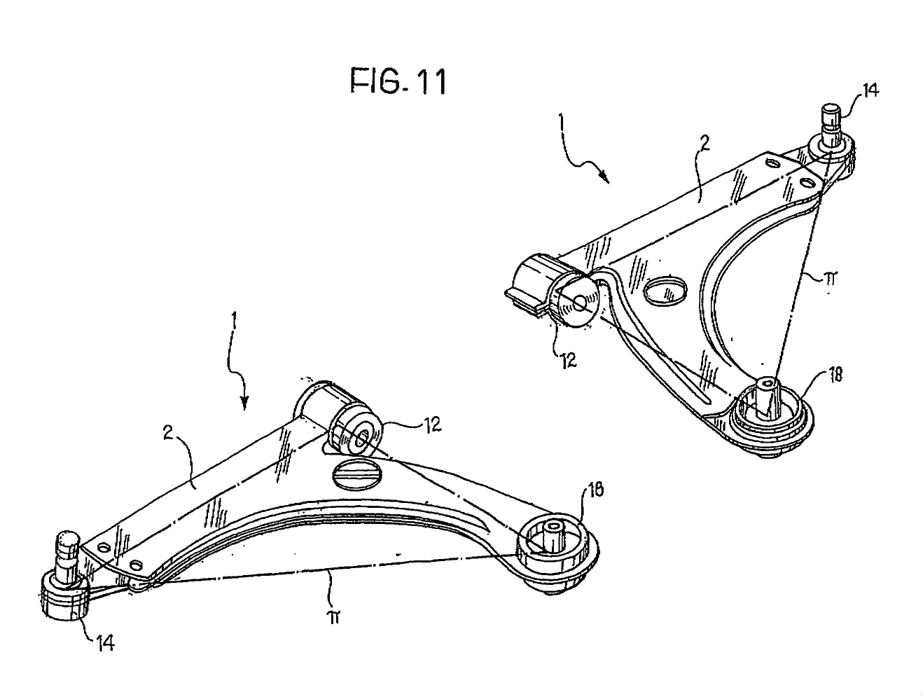

FIG. 11 is a perspective view which illustrates an example of use of the structural member of FIG. 9 for both the left-hand and the right-hand arm of a motor vehicle suspension;

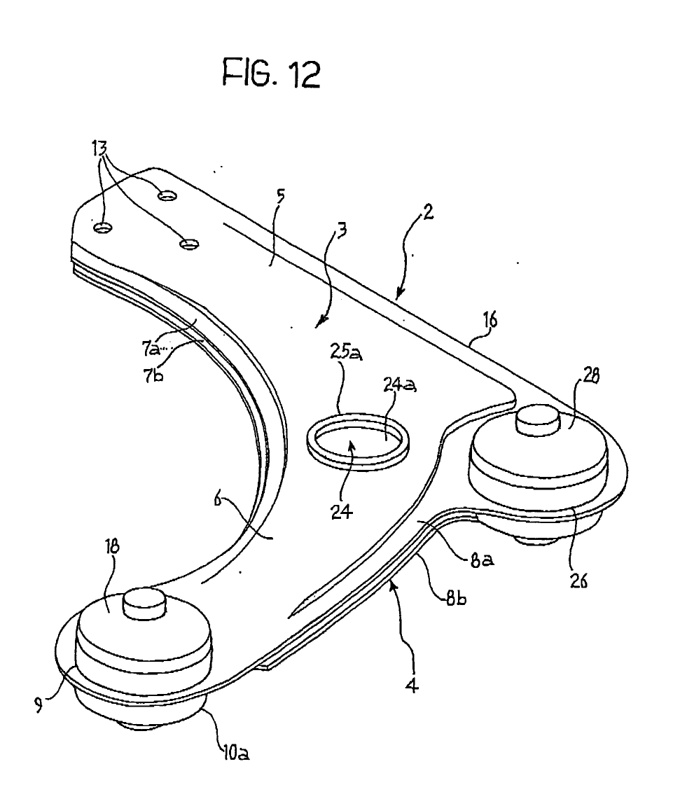

FIG. 12 is a perspective view of another preferred embodiment of a structural member with box-like structure according to the invention;

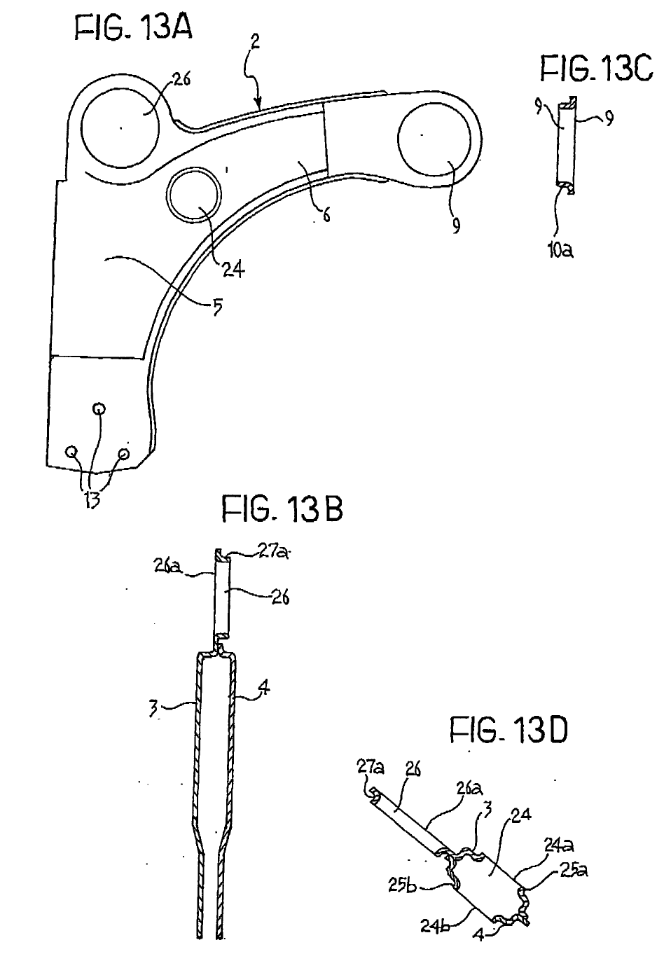

FIGS. 13A to 13D are a plan view (FIG. 13A) and three sectional views (FIGS. 13B-13D) in three different vertical planes of the structural member of FIG. 12; and

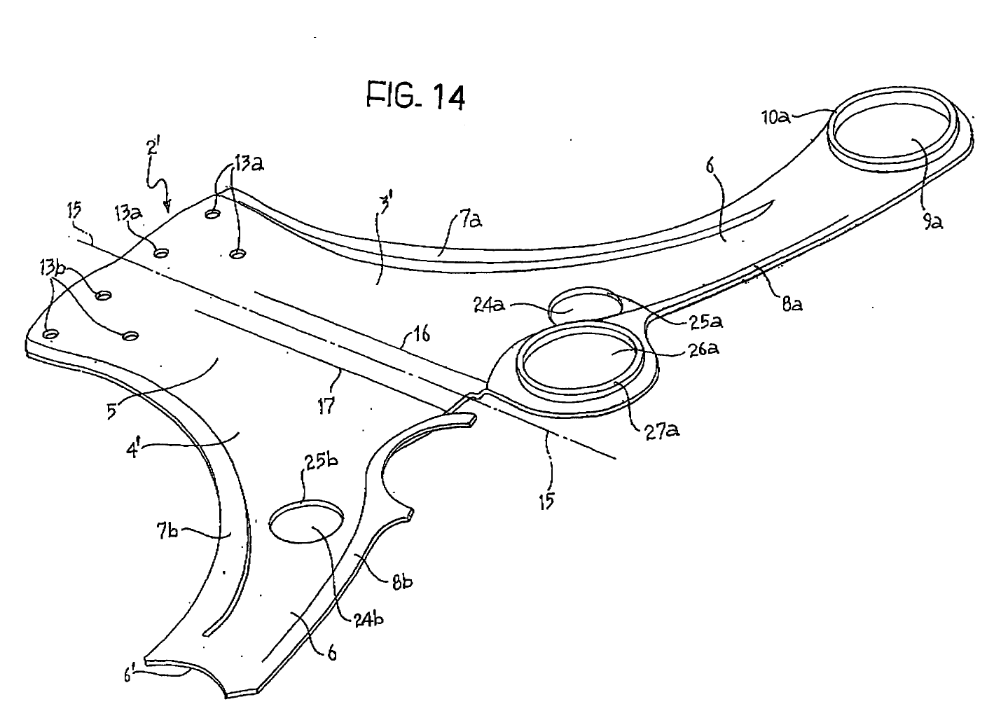

FIG. 14 is a perspective view of a semi-finished product from which the structural member of FIG. 12 is obtained by successive folding operations.

With reference to FIGS. 1 and 2, an arm of a motor vehicle suspension, generally indicated 1, comprises a structural member 2 with box-like structure, of substantially rectangular section, consisting of a first and a second portion 3 and 4 in the form of a respectively upper and lower half-shell. Said portions 3 and 4 are disposed facing each other with respect to a horizontal plane π, which is advantageously parallel to the planes in which they substantially lie.

The structural member 2 of the suspension arm 1 comprises a straight limb 5, constituted in part by the aforesaid first portion 3 and in part by the second portion 4. The limb 5 has a substantially vertical lateral face 5′ (visible in FIG. 2), the upper edge 16 and lower edge 17 of which correspond to fold lines of the product. Connected to the limb 5, on the opposite side from the face 5′, there is a second curved limb 6, also constituted in part by the upper portion 3 and in part by the lower portion 4 of the member 2.

The limbs 5 and 6 are of such dimensions and shape and are so arranged that their free ends are located at the vertices of a substantially right-angled triangle lying in a plane preferably coplanar with the plane π.

On the lateral face of the straight limb 5 that is connected to the curved limb 6, as on both the lateral faces of the latter, the two facing portions 3 and 4 of the structural member 2 have joining edges 7a, 7b, 8a and 8b (the latter not visible in FIGS. 1 and 2), where the numerals 7 and 8 refer to the lateral faces of the arm having in plan substantially a concave and convex profile, respectively, while the two letter indices a and b refer to the two portions, upper 3 and lower 4, respectively.

In the embodiment illustrated in FIGS. 1 and 2, said edges are of the superposed type: that is to say, they have the same shape, substantially flat and parallel to the plane in which lies the shaped element constituting the initial semi-finished product. Consequently, after the operations of folding over the two plate portions of the semi-finished product along the lines 16 and 17, which impart the definitive spatial arrangement to the two portions 3 and 4 of the structural member 2, the joining edges are facing one another and superposed with respect to the horizontal plane π, and can thus be rigidly connected to each other, preferably by means of seam welding.

As illustrated in FIGS. 6A to 6F, as an alternative to a superposed form and arrangement, adapted to connection by means of seam welding (FIG. 6A), any joining edges can assume various forms and arrangements, for example:

butted form and arrangement for fixing by means of seam welding (FIG. 6B);

plat band form and arrangement for fixing by means of spot welding (FIG. 6C);

form and arrangement with superposed edges for fixing by means of rivetting (FIG. 6D); or

form and arrangement with superposed edges of suitable width for securing by adhesive or clinching (FIGS. 6E, 6F).

The fixing edges 7a, 7b, 8a and 8b (FIGS. 1 and 2) and before the free end of the curved limb 6, where a cylindrical seat 9 is provided to receive an intermediate connection device, such as a bush 18 with vertical axis (not shown). The seat 9 is obtained by the superposition of two circular holes 9a and 9b, produced respectively in the upper portion 3 and lower portion 4 of the structural member 2, so that they are coaxial with each other at the end of the operations of folding along the lines 16 and 17. In the region of the limb 6 surrounding the seat 9, the two portions 3 and 4 of the member 2 are therefore simply facing one another.

The holes 9a and 9b which form the seat 9 advantageously have respective circumferential edges 10a and 10b turned vertically towards the internal cavity of the structural member 2 and adapted to ensure centring and locking of the intermediate connection device (bush 18) between the two facing portions 3 and 4.

On the curved limb 6, in proximity to the area of connection to the straight limb 5, a further cylindrical seat 24 with vertical axis is formed, also adapted to the fixing of an intermediate connection device such as a bush. Said seat is obtained by superposing two circular holes 24a and 24b, produced respectively in the upper portion 3 and the lower portion 4 of the structural member, so that they are coaxial with each other at the end of the operations of folding along the lines 16 and 17. Like the holes 9a and 9b, the holes 24a and 24b also have respective circumferential edges 25a and 25b, in this case turned vertically towards the outside of the structural member 2, instead of towards the internal cavity, but having a similar function.

One of the two ends of the straight limb 5 has two appendages 11a and 11b, each associated with one of the two facing portions 3 and 4, being suitably shaped and opened out for stable retention of a bush 12 with horizontal axis, by engaging with the lateral cylindrical surface of the latter.

At the opposite end of the limb 5, three pairs of non-aligned apertures 13a and 13b (these latter not being visible in FIGS. 1 and 2, but only in FIG. 3) are provided respectively in the two portions, upper 3 and lower 4, of the member 2, so as to be coaxial two by two after the folding operations. Each pair of apertures, preferably circular in shape, thus defines a cylindrical seat 13 into which is inserted a bolt for fixing a bracket member 20 carrying an articulation support 14. The locking of the bracket member 20, which extends for part of its length inside the internal cavity of the box-like structure at one end of the limb 5, can be effected in various other ways, for example by rivetting, as is well known to an expert in the field.

FIG. 3 shows a plan view of the starting semi-finished product, consisting of a shaped element 2′ with two plate portions 3′ and 4′, integrally produced therewith and corresponding respectively to the two portions 3 and 4 in the shape of a half-shell of the box-like member. The semi-finished product 2′ is obtained by blanking from a sheet of steel, aluminium or plastics material (of the thermoplastic or thermosetting type, if necessary reinforced by the addition of glass, carbon or Kevlar fibres). The starting material in sheet form can have a constant or variable thickness (also termed multi-layer). In this second case the sheet is of a particular type, produced appropriately on the basis of the type of application, which has areas of different thickness according to the nature and distribution of the stresses to which the structural member is subject in operation.

In the exemplary embodiment described here, the starting semi-finished product has a shape symmetrical with respect to an axis 15, as can be clearly seen in FIG. 3. Still with reference to said figure, it is also possible to identify for each of the two plate portions 3′ and 4′ the details of the finished product described above, that is to say, the two limbs, straight 5 and curved 6, the joining edges 7a, 7b, 8a and 8b, the circular holes 9a, 9b and 24a, 24b respectively defining the cylindrical seats with vertical axis 9 and 24, the shaped appendages 11a and 11b for retaining the bush 12 with horizontal axis, and the holes 13a and 13b for the engagement of the bracket member 20 carrying the articulation support 14.

A description will now be given of the method of production of the structural member 2 according to the present invention. The first operation consists in blanking the starting material in sheet form to obtain a semi-finished product 2′ (FIG. 3) suitably shaped so that its two integral plate portions 3′ and 4′ correspond to the development in plan view of the half-shell portions 3 and 4 of the structural member 2. At this point a first series of shaping and folding operations are carried out which essentially involve the joining edges 7a, 7b, 8a and 8b, the edges 10a, 10b and 25a, 25b of the circular holes 9a, 9b and respectively 24a, 24b, and the appendages 11a and 11b, to impart the final half-shell shape to the plate portions 3′ and 4′.

In the example described here, the two portions 3 and 4 of the structural member 2 are in the shape of concave half-shells, that is to say, the respective cross-sections in planes perpendicular to the axis of symmetry 15 have a substantially concave profile. It is possible, however, to arrange said portions so as to obtain different combinations of shape of the two half-shells, such as, for example, concave/flat, concave/convex and convex/convex (FIGS. 5B to 5D).

A successive step of the production method according to the invention consists in folding over the shaped element 2′ of FIG. 3 along at least one predetermined line, so as to dispose the respective portions 3 and 4 thereof substantially facing each other. With reference to FIG. 4, in the exemplary embodiment under consideration the semi-finished product 2′ is subjected in sequence to a first and a second folding operation at right-angles, respectively along the lines 17 and 16, parallel to each other and symmetrical with respect to the axis 15, so as to bring together the inner faces of the joining edges 7a, 7b, 8a and 8b.

As is known, each of the folding operations is carried out by using, for example, a core of prismatic shape (not shown) the length of which is equal at least to that of the folding line and the cross-section of which forms at least one angle equal to the desired folding angle. Folding is thus carried out at first by placing one of the folding faces of the core (that is to say, one of the faces of the core forming the desired folding angle) on the inner face of one of the two plate portions of the semi-finished product, so that the edge corresponding to the vertex of said angle is positioned at the folding line on the semi-finished product, and then rotating the other plate portion of the semi-finished product about the predetermined folding line until its inner face abuts the second of the aforesaid folding faces.

If intermediate connection devices are provided, such as bushes, a successive step of the production method provides for the insertion of said devices. FIGS. 7A and 7B illustrate two different solutions for the mounting of the bush 18 with vertical axis in the cylindrical seat 9. As described previously, the seat 9 is obtained by the superposition of the two circular holes 9a and 9b, formed in the plate portions 3′ and 4′ of the semi-finished product 2′ in a position such that the holes are disposed coaxially with each other following the aforesaid folding operations. Moreover said holes are preferably provided with circumferential edges 10a and 10b folded over towards the inside of the member 2 perpendicularly to the plane in which the sheet lies.

With reference to FIG. 7A, the bush 18 is inserted in the direction indicated by the arrow F into the seat 9, where it remains blocked by interference with the lateral surfaces of the edges 10a and 10b. To facilitate the insertion of the bush it is convenient to use a removable spacer 21 which holds the two facing portions 3 and 4 in position during said operation. FIG. 7B illustrates a bush 18 with vertical axis, used as an intermediate connection device, provided with a flange 19 adapted to function as end stop for the insertion into the seat 9.

Similar considerations apply for the mounting of any further intermediate connection device, such as a bush, in the cylindrical seat 24 with vertical axis.

Where joining edges are provided, as in the preferred exemplary embodiment considered here, after folding, said edges are then fixed to each other, in a manner described previously with reference to FIGS. 6A to 6F (seam welding or spot welding, rivetting, securing by adhesive, or clinching).

It is likewise possible, according to particular requirements of structural strength or of the process, to complete the manufacture of the arm by the introduction of filling materials, such as structural foams, into the cavity within the box-like structure.

In the preferred embodiment described with reference to FIGS. 1 to 4, the structural member 2 is substantially rectangular in cross-section. It is possible, however, to produce box-like structures with cross-sections of different shape, either closed, such as for example a triangular shape, teardrop-shape or recumbent T-shape (FIGS. 8A to 8C), or open, such as for example a C-shape (FIG. 8D).

FIGS. 9 and 10 illustrate a further preferred embodiment of the invention, in which the same reference numerals have been assigned to parts and elements similar or identical to those illustrated in the preceding figures.

Said embodiment differs from that described previously with reference to FIGS. 1 to 4 in the following characteristics.

First of all, the cylindrical seat 9, capable of receiving an intermediate connection device, such as a bush 18 with vertical axis (not shown), is produced with the single circular hole 9a, provided with a circumferential edge 10a, formed in the upper portion 3 of the member 2. The semi-finished product 2′ therefore no longer has a shape symmetrical with respect to the axis 15 (FIG. 10), since the lateral development of the curved limb 6 of the plate portion 4′ is interrupted at an edge 6′, before forming an end portion corresponding to that of the other plate portion in which the hole 9b is formed.

Even if not expressly illustrated and described, it is obviously possible, without thereby departing from the scope of the invention, to produce the cylindrical seat 9 with a single hole 9b in the lower portion 4 of the structural member 2.

Said solution makes it possible to reduce the production costs further, owing to the minimisation of the scrap caused by the initial blanking operation. Another advantage lies in the fact that the production of the cylindrical seat 9 by means of a single hole 9a or 9b in one of the two portions 3 and 4 of the structural member 2, instead of by means of both the holes 9a and 9b in the two portions 3 and 4, avoids the need to define tight limits of tolerance in the mutual positioning of said holes, thus further contributing to the reduction of the costs of manufacture of the member.

Another difference between this second preferred embodiment and the first lies in the arrangement for fixing the bush 12 with horizontal axis. In this case fixing is ensured by a circumferentially closed seat 22, comprised between two semicircular appendages 22a and 22b, which extend longitudinally from the straight limbs 5 of the two portions 3 and 4 of the member 2. The appendages 22a and 22b advantageously have joining edges 23a and 23b respectively, which may have shapes and arrangements of the same type as those described with regard to the edges 7a, 7b, 8a, 8b for joining the limbs 5 and 6 of the two facing portions 3 and 4.

FIG. 11 shows how the structural member 2 can be used according to the invention to form both the left-hand and right-hand arms of the same motor vehicle suspension, without the need to differentiate the designs and methods of production of the member intended for the left-hand arm with respect to that intended for the right-hand arm.

Finally, referring to FIGS. 12 to 14, wherein the same reference numerals have been assigned to parts and elements similar or identical to those illustrated in the preceding figures, a further alternative embodiment of the structural member 2 according to the invention can be observed. Said alternative embodiment differs from the embodiment previously illustrated with reference in particular to FIG. 9, in that at the opposite end of the straight limb 5 from that in which the seats 13 for fixing the bracket member 14 (which is not shown) are provided, it has a cylindrical seat 26 with vertical axis instead of horizontal.

The seat 26, which is capable of receiving a connection device 28, such as a bush (FIG. 12), is formed in a similar manner to the cylindrical seat 9 at the end of the curved limb 6. It in fact comprises a single circular hole 26a, advantageously provided with a circumferential edge 27a, formed in the upper portion 3 of the member 2, as can be clearly observed in particular in FIGS. 13B and 13D, which show two sectional views of the member 2 in two different planes passing through the axis of the seat 26.

Naturally, with the principle of the invention remaining the same, the embodiments and the details of production may be widely varied with respect to what has been described and illustrated purely by way of non-limiting example, without thereby departing from the scope of the invention as defined in the appended claims.

1. A structural member (2), in particular for an arm (1) of a motor vehicle suspension, comprising a pair of shaped portions (3, 4) disposed facing each other to form a box-like structure, characterised in that said shaped portions are obtained from a pair of integral plate portions (3′, 4′) of a semi-finished product (2′) in the form of a shaped essentially flat element of produced starting from a plastically deformable material in sheet form, by folding over said shaped element along at least one predetermined line (16, 17), so as to dispose said plate portions (3′, 4′) facing each other.

2. A structural member according to claim 1, of the type in which the portions (3, 4) are maintained in a stable manner facing each other by means of at least one intermediate connection device with vertical axis (18, 28), separate from the aforesaid portions, characterised in that at least one integral plate portion (3′, 4′) of the semi-finished product (2′) has at least one hole (9a, 9b, 24a, 24b, 26a) adapted to receive said at least one intermediate connection device (18, 28).

3. A structural member according to claim 2, characterised in that said at least one hole (9a, 9b, 24a, 24b) in a plate portion (3′, 4′) of the semi-finished product (2′) is associated to a respective hole (9b, 9a, 24b, 24a) on the other plate portion (4′, 3′), positioned such that at the end of the folding process the structural member (2) has at least one pair of coaxial holes (9a, 9b; 24a, 24b) defining a cylindrical seat (9, 24) for mounting said at least one intermediate connection device (18).

4. A structural member according to claim 2 or 3, characterised in that the holes (9a, 9b, 24a, 24b, 26a) have respective peripheral edges (10a, 10b, 25a, 25b, 27a) folded over parallel to their axis so as to define lateral guiding and retaining surfaces for mounting said at least one intermediate connection device (18, 28).

5. A structural member according to claim 4, characterised in that said at least one intermediate connection device (18, 28) is a bush, capable of being blocked by interference with the inner lateral surfaces of the peripheral edges (10a, 10b, 25a, 25b, 27a).

6. A structural member according to any one of the preceding claims, characterised in that the plate portions (3′, 4′) of the semi-finished product (2′) have respective pluralities of apertures (13a, 13b) positioned so as to be coaxial two by two at the end of the folding process and thus define a corresponding plurality of cylindrical seats (13) for the insertion of means for fixing outer support members (20).

7. A structural member according to claim 6, characterised in that said outer support members comprise a bracket member (20) carrying an articulation support (14).

8. A structural member according to any one of the preceding claims, characterised in that it comprises a pair of shaped appendages (11a, 11b, 22a, 22b) adapted to clamp a bush (12) with horizontal axis, said appendages being provided on both the plate portions (3′, 4′) of the semi-finished product (2′) so as to be facing each other at the end of the folding process.

9. A structural member according to any one of the preceding claims, characterised in that the plate portions (3′, 4′) of the semi-finished product (2′) have respective joining edges (7a, 7b, 8a, 8b) shaped and positioned such that after the folding process they are capable of being joined along at least a portion of their extent.

10. A structural member according to claim 9, characterised in that said edges (7a, 7b, 8a, 8b) are joined by means of seam welding or spot welding.

11. A structural member according to claim 9, characterised in that said edges (7a, 7b, 8a, 8b) are joined by means of rivetting, securing by adhesive, or by clinching.

12. A structural member according to any one of the preceding claims, characterised in that it is made of metallic material (such as steel or aluminium), of plastics material (such as thermoplastic or thermosetting plastics, reinforced if necessary with reinforcing fibres), or of composite material.

13. A structural member according to any one of the preceding claims, characterised in that into the cavity within the portions (3, 4) there is introduced a filling material such as a structural foam.

14. A structural member according to any one of the preceding claims, characterised in that the starting material from which the semi-finished product (2′) is obtained is a sheet with areas of different thickness.

15. A method for the production of a structural member (2), in particular for an arm (1) of a motor vehicle suspension, the member (2) including a pair of shaped portions (3, 4) disposed facing each other, characterised in that it comprises the operations of:
providing, by means of blanking, a semi-finished product (2′) in the form of a shaped, essentially flat element, starting from a substantially rigid and plastically deformable-material in sheet form, said shaped element having a first and a second plate portion (3′, 4′) integral therewith and of predetermined shape;
folding over the shaped element (2′) along at least one predetermined line (16, 17), so as to dispose the plate portions (3′, 4′) facing each other; and
stabilising the portions (3, 4) so that they remain facing each other.

16. A method according to claim 15, characterised in that it comprises the operations of:
forming at least one hole (9a, 9b, 24a, 24b, 26a) in at least one plate portion (3′, 4′) of the semi-finished product (2′), before the folding over of the latter;
after the folding process, inserting into said at least one hole (9a, 9b, 24a, 24b, 26a) at least one intermediate connection device (18, 28).

17. A method according to claim 15, characterised in that it comprises the operations of:
for each hole (9a, 9b, 24a, 24b) in a plate portion (3′, 4′) of the semi-finished product (2′), forming, before the folding process, a corresponding hole (9b, 9a, 24b, 24a) in the other plate portion (4′, 3′), said holes being positioned so as to be coaxial two by two after folding and thus to define cylindrical seats (9, 24) adapted to receive said at least one intermediate connection device (18);
at the end of the folding process, inserting into each cylindrical seat (9, 24) the corresponding intermediate connection device (18).

18. A method according to claim 16 or 17, characterised in that it comprises the operation of turning over inner edges (10a, 10b, 25a, 25b, 27a) of the holes (9a, 9b, 24a, 24b, 26a) parallel to their axis, before the insertion of the intermediate connection device (18, 28) so as to provide lateral guiding and retaining surfaces for the latter.

19. A method according to claim 18, characterised in that, after the operation of turning over the edges (10a, 10b, 25a, 25b, 27a) of the holes (9a, 9b, 24a, 24b, 26a), a bush (18, 28) is inserted into said holes by interference with the lateral surfaces of their edges.

20. A method according to any one of claims 15 to 19, characterised in that it comprises the operations of:
providing in the plate portions (3′, 4′) of the semi-finished product (2′), before folding over, respective pluralities of apertures (13a, 13b), positioned so as to be facing and coaxial with each other two by two at the end of the folding operation, to define a corresponding plurality of cylindrical seats (13); and
after the folding operation, inserting into the cylindrical seats (13) fixing means for outer support members (20).

21. A method according to any one of claims 15 to 20, characterised in that:
by means of the initial operation of blanking the profile of the semi-finished product (2′), two appendages (11a, 11b, 22a, 22b) are produced, one for each plate portion (3′, 4′), disposed so as to be facing each other at the end of the operation of folding said plate portions; and that
before the folding operation, the appendages are shaped so as to be capable of clamping a bush (12) with horizontal axis.

22. A method according to any one of claims 15 to 21, characterised in that it comprises the operations of:
before the folding of the plate portions (3′, 4′) of the semi-finished product (2′), providing, by folding, joining edges (7a, 7b, 8a, 8b) having a shape such as to be facing one another at the end of the aforesaid folding operation; and
after the folding of the two plate portions (3′, 4′) of the semi-finished product (2′), rigidly connecting the joining edges (7a, 7b, 8a, 8b) along at least a part of their extent.

23. A method according to any one of claims 15 to 22, characterised in that it comprises, after the folding of the plate portions (3′, 4′) of the semi-finished product (2′), an operation of introducing a filling material, such as a structural foam, into the internal cavity of the structural member (2) comprised within its facing portions (3, 4).

24. A method according to any one of claims 15 to 23, characterised in that a starting material in the form of a sheet having areas of different thickness is used.
